(19) United States
(12) Patent Application Publication
(10) Pub. No.: US 2006/0162652 A1
(43) Pub. Date: Jul. 27, 2006

(54) Container for an apparatus for automated cryosubstitution or low-temperature substitution

(76) Inventors: Anton Lang, Vienna (AT); Rainer Wogritsch, Vienna (AT); Paul Wurzinger, Deutsch-Wagram (AT)

Correspondence Address: HODGSON RUSS LLP, ONE M & T PLAZA, SUITE 2000, BUFFALO, NY, 14203-2391, US

(21) Appl. No.: 11/332,126

(22) Filed: Jan. 13, 2006

(30) Foreign Application Priority Data
Jan. 25, 2005 (DE) 10 2005 003 286.9

(51) Int. Cl. F17C 13/00; F25B 19/00; B05C 19/02; G01N 1/00; B05C 3/00

(52) U.S. Cl. 118/429; 220/560.1; 62/51.1; 436/176; 118/423

(57) ABSTRACT

A container (50) for an apparatus for automated cryosubstitution or low-temperature substitution is disclosed. The container is embodied as a cup (51) open at the top. The container (50) is subdivided into a first sector (52) and a second sector (53), at least one specimen holder (2) being arranged in the first sector (52) and at least one reservoir holder (20) in the second sector (53); and the container is arranged in the neck of a Dewar vessel (1).

### CROSS REFERENCE TO RELATED APPLICATIONS

This application claims priority of the German patent application 10 2005 003 286.9 filed Jan. 25, 2005 which is incorporated by reference herein.

### FIELD OF THE INVENTION

The invention relates to a container for an apparatus for automated cryosubstitution or low-temperature substitution. The invention relates in particular to a container for an apparatus for automated cryosubstitution or low-temperature substitution, the container being embodied as a cup open at the top.

### BACKGROUND OF THE INVENTION

The brochure for the Leica EM AFS discloses a unit according to the existing art. A Dewar vessel is filled with liquid nitrogen, the Dewar neck comprising a chamber or a container that can be brought to a specific temperature. The temperature range extends from −140° C. to +65° C. The desired temperature is set via a control loop and built-in heating elements. A reservoir of reagents in the chamber or the container is not provided.

German Utility Model DE 91 04 344.1 discloses a cooling device for specimen preparation for an electron microscope. The cooling device encompasses a holding insert that is subdivided into at least two segments. Both segments are equipped with orifices, of which the orifices in one segment serve to retain a container for the specimens to be freeze-dried. Reservoir vessels having reagents are retained in the orifices of the other segment. The specimens and the reagents are thereby cooled to the required working temperature. An automatic transfer of the reagents from one region of the container into the next is not disclosed.

### SUMMARY OF THE INVENTION

It is therefore the object of the present invention to create a container that is suitable for the automation of manual activities in the context of cryosubstitution or low-temperature substitution.

The above object is achieved by a container for an apparatus for automated cryosubstitution or low-temperature substitution, which container encompasses the features that the container being embodied as a cup open at the top, the container is subdivided into a first sector and a second sector; at least one specimen holder is arranged in the first sector and at least one reservoir holder in the second sector; and the container is designed to be arranged in the neck of a Dewar vessel.

It is advantageous if the container is subdivided into a first sector and a second sector, at least one specimen holder being arranged in the first sector and at least one reservoir holder in the second sector, and the container being insertable into a chamber in the neck of a Dewar vessel or itself forming that chamber.

The first sector is constituted by an insert into the container that comprises at least one holding position for the specimen holder. For better utilization of the space available, the insert comprises two holding positions for the specimen holder. The insert has substantially the shape of a circle sector. The circle sector has an opening angle of less than 180°, and is embodied with a center axis that substantially aligns with an axis of an apparatus for automated cryosubstitution or low-temperature substitution.

The second sector is an annulus sector that encompasses the portion of the container unoccupied by the insert. Multiple reservoir holders are arranged directly adjacent to one another in the annulus sector.

The reservoir holders possess a closable opening through which liquid is removable or returnable. The openings are arranged on a circle within the cup and face the open top of the cup. The reservoir holders have a basal surface in the shape of an annulus sector.

The insert for the specimen holder, the specimen holder itself, and the reservoir holders are each manufactured in one piece from a plastic.

### BRIEF DESCRIPTION OF THE DRAWINGS

Further advantages and advantageous embodiments of the invention may be inferred from the dependent claims and are the subject matter of the Figures below and the descriptions thereof. In the individual drawings:

FIG. 1 is a cross section through a Dewar vessel;

FIG. 2 schematically depicts a Dewar vessel onto which an apparatus for automated cryosubstitution or low-temperature substitution is placed;

FIG. 3 is a perspective view of a container for receiving at least one specimen holder and at least one reservoir holder;

FIG. 4 is a top view of the container for receiving at least one specimen holder and at least one reservoir holder;

FIG. 5a is a sectioned view of a first embodiment of a specimen insert for the specimen holder, a first embodiment of the compartments for receiving a specimen being depicted in the specimen insert;

FIG. 5b is a sectioned view of a second embodiment of a specimen insert for the specimen holder, a second embodiment of the compartments for receiving a specimen being depicted in the specimen insert;

FIG. 6a is a perspective top view of the first embodiment of the compartments;

FIG. 6b is a perspective bottom view of the first embodiment of the compartments;

FIG. 7 is an enlarged perspective bottom view of some of the compartments; and

FIG. 8 is a perspective view of an insert of the container for receiving at least one specimen holder.

### DETAILED DESCRIPTION OF THE INVENTION

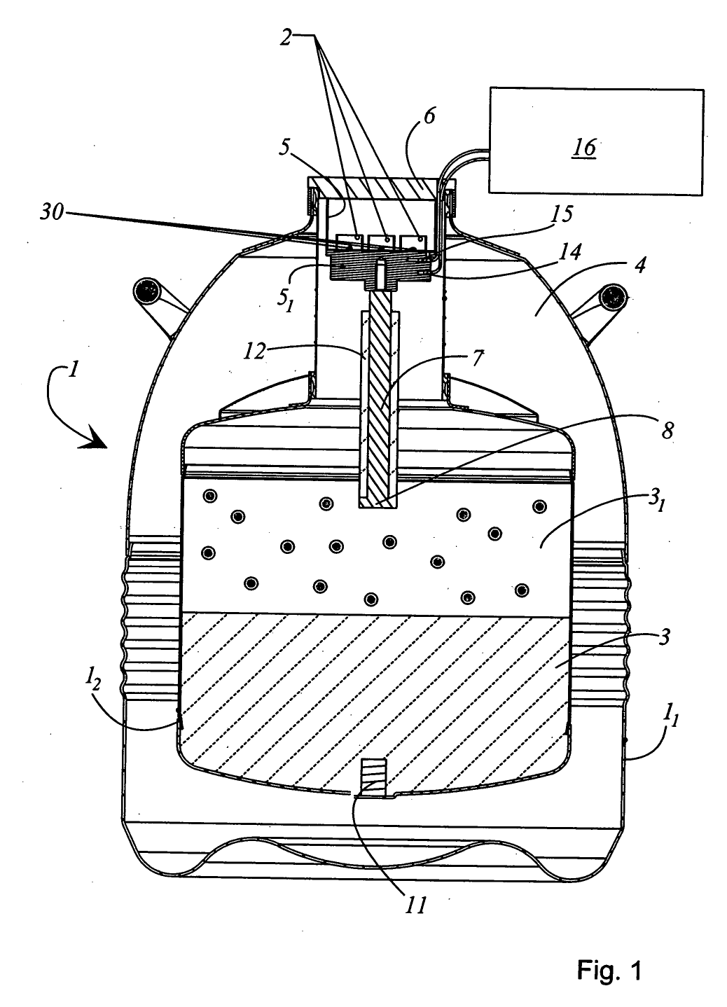

FIG. 1 is a cross section through one possible embodiment of a Dewar vessel 1. In the description that follows, identical reference characters are used for identical elements. The cooling apparatus shown in FIG. 1 serves for cryosubstitution or low-temperature substitution of biological and/or other water-containing specimens. The Dewar vessel encompasses an inner container 1₂ and an outer container 1₁. The inner container is filled with a liquid cooling agent that is preferably liquid nitrogen 3. A chamber 5 is inserted into the neck of Dewar vessel 1. Chamber 5 is cup-shaped and possesses a heavy base 5₁. Chamber 5 is open at the top and can be closed off with a cover 6 for insulation with respect to ambient temperature. Chamber 5 serves to receive one or more specimen holders 2 in which specimens 30 for cryosubstitution or low-temperature substitution are located. A first thermal conduction rod 7 is joined to base 5₁ of chamber 5. A platform 8 is provided at the end of first thermal conduction rod 7 facing away from base 5₁ of chamber 5. Platform 8 can be detachably joined to first thermal conduction rod 7. It is also conceivable for first thermal conduction rod 7 and platform 8 to be embodied integrally. Above platform 8, first thermal conduction rod 7 is surrounded by an insulator 12. Insulator 12 serves to insulate first thermal conduction rod 7 with respect to liquid nitrogen 3 or cold nitrogen gas 3₁. Insulator 12 causes the heat flux that cools chamber 5 or base 5₁ to be directed principally via platform 8. The cooling power can therefore advantageously be determined by modifying the geometrical dimensions or selecting a suitable material for first thermal conduction rod 7. The temperature in chamber 5 can be regulated by operating at least one heating element 14. Also provided is at least one temperature sensor 15 that is used for temperature measurement. Temperature sensor 15 can be embodied as a thermocouple or a resistance temperature sensor. The temperature signal is used as feedback for an electronic regulating system 16 that controls the temperature of chamber 5 by adapting the heating output of heating element 14. The length of first thermal conduction rod 7 is advantageously selected in such a way that platform 8 is immersed in liquid nitrogen 3 only when a certain fill level is reached. With a high fill level, platform 8 is immersed in liquid nitrogen 3, and chamber 5 is coupled via first thermal conduction rod 7 directly to liquid nitrogen 3. With a low fill level, platform 8 interacts with cold nitrogen gas 3₁. Cold nitrogen gas 3₁ is heated by the heat flux from chamber 5 into inner container 1₂ of Dewar vessel 1. By convection and by interaction with the walls of inner container 1₂, this heat is fed back into liquid nitrogen 3 and causes an increase in the evaporation rate. The result is that platform 8 and chamber 5 arrive at an equilibrium temperature that is largely independent of the present fill level of liquid nitrogen 3 in inner container 1₂. It is self-evident that the thermal coupling between chamber 5 and liquid nitrogen 3 is much greater at a high fill level than at a low fill level. Lower temperatures in chamber 5 can therefore be attained with a high fill level. On the other hand, the consumption of liquid nitrogen is lower with a low fill level.

This arrangement is advantageous in that in standard substitution processes, the lowest process temperatures (−90° C. and below) are needed at the beginning of the processes. The temperature is raised in the course of the substitution processes. Because liquid nitrogen 3 is also consumed during the process, the cooling power achievable by way of first thermal conduction rod 7 and platform 8 reflects the temperature profile of the substitution process. At the same time, insulator 12 also limits the coupling to liquid nitrogen 3 when the fill level is high. High temperatures can therefore be set even in this situation, with no need to exceed reasonable limits for nitrogen consumption and for the requisite heating output of heating element 14.

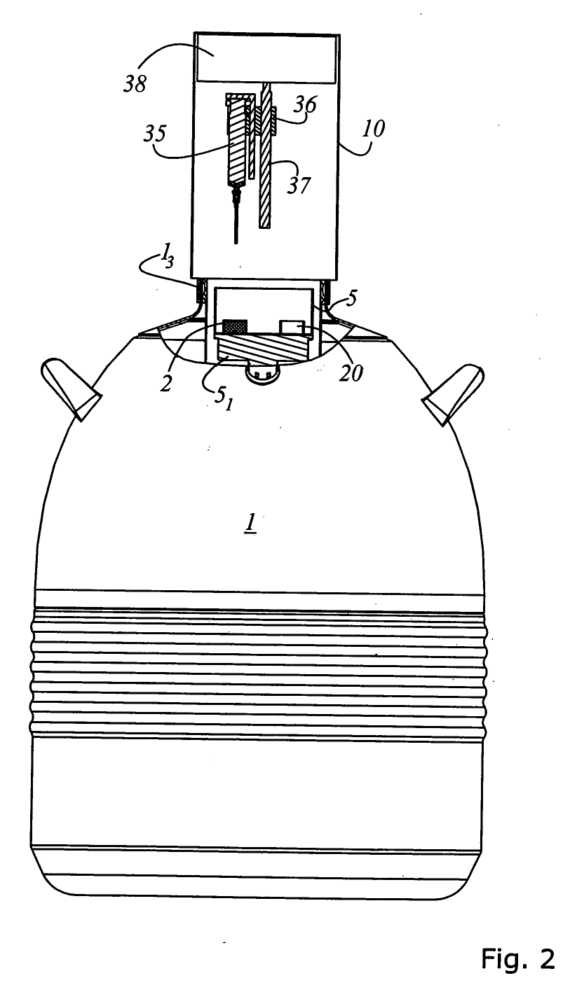

FIG. 2 schematically depicts a Dewar vessel 1 onto which apparatus 10 for automated cryosubstitution or low-temperature substitution is placed. A chamber 5 is inserted into neck 1₃ of Dewar vessel 1. Chamber 5 is cup-shaped and possesses a heavy base 5₁. Chamber 5 is open at the top. Chamber 5 is embodied as a container that encompasses at least one specimen holder 2 and at least one reservoir holder 20.

It is also conceivable for the container that encompasses the at least one specimen holder 2 and the at least one reservoir holder 20 to be embodied separately from chamber 5 and inserted thereinto. A movable transfer container 35 is provided for automated exchange of at least one liquid between the at least one specimen holder 2 and the at least one reservoir holder 20. Apparatus 10 can be immovably joined to Dewar vessel 1. It is also conceivable for apparatus 10 to be embodied removably from Dewar vessel 1. Apparatus 10 is embodied, for example, as a module that can be placed as necessary, for example by the user, onto a Dewar vessel 1. Transfer container 35 is a syringe or a pipette. The liquid is taken into or ejected from transfer container 35 in motorized, pneumatic, or hydraulic fashion. Apparatus 10 is equipped for that purpose with an actuation element 36 with which motorized, pneumatic, or hydraulic intake or ejection of the liquid into or from transfer container 35 is accomplished. A control unit 38 is provided which performs the liquid transfer between the at least one specimen holder 2 and the at least one reservoir holder 20 in remotely controlled fashion. Transfer container 35 moves correspondingly back and forth, thus enabling the liquid transfer. Transfer container 35 can move up and down along an axis 37. Control unit 38 is what makes possible programming of a chronological sequence of transfer steps between the at least one reservoir holder 20 and the at least one specimen holder 2.

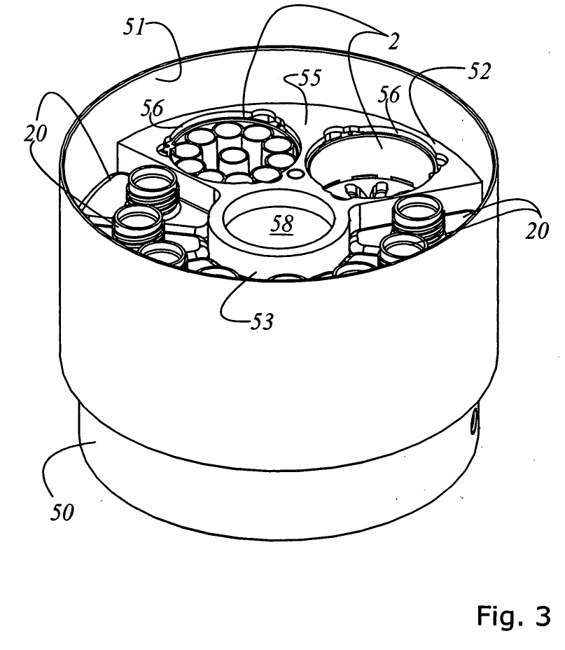

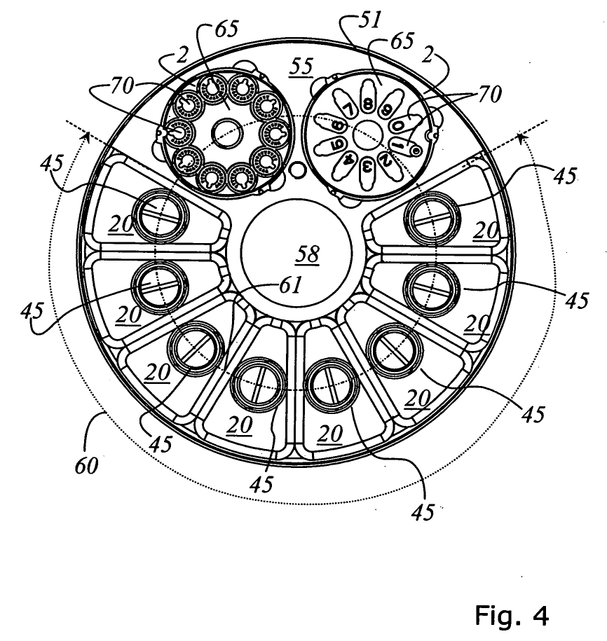

FIG. 3 is a perspective view of container 50 for receiving at least one specimen holder 2 and at least one reservoir holder 20. In the embodiment depicted here, container 50 is configured as a cup 51 open at the top. Container 50 is subdivided into a first sector 52 and a second sector 53. The at least one specimen holder 2 is provided in first sector 52. Reservoir holders 20 are provided in second sector 53. Specimen holders 2 are suitable for receiving different types of specimen containers. Reservoir holders 20 are embodied as bottles and are inserted into second sector 53. Second sector 53 has the shape of an annulus sector 60 (see FIG. 4), so that each of reservoir holders 20 likewise has the shape of an annulus sector. First sector 52 is formed by an insert 55 in cup 51, insert 55 comprising at least one holding position 56 for specimen holder 2. According to the preferred embodiment, insert 55 possesses two holding positions 56 for specimen holders 2. The circle sector of insert 55 possesses an opening angle of less than 180°. Insert 55 is furthermore embodied with a center axis 58 that substantially aligns with an axis 37 of apparatus 10 for automated cryosubstitution or low-temperature substitution.

FIG. 4 is a top view of container 50 for receiving at least one specimen holder 2 and at least one reservoir holder 20. As already mentioned, second sector 53 is an annulus sector 60 that encompasses the portion of cup 51 unoccupied by insert 55. Multiple reservoir holders 20 are arranged immediately adjacent to one another in annulus sector 60. Each reservoir holder 20 possesses a closable opening 45 through which liquid is removable or returnable. Openings 45 are arranged on a circle 61 within cup 51 such that the openings face the open top of the cup. Each of specimen holders 2 is equipped with a specimen insert 65 for storing and/or holding the specimens during cryosubstitution or low-temperature substitution. Specimen insert 65 received by specimen holder 2 is manufactured in one piece from a plastic. Polyethylene or polypropylene is preferably used as the plastic for the manufacture of specimen inserts 65. Reservoir holders 20 are also manufactured from a plastic, for example polyethylene or polypropylene. Specimen holders 2 are likewise manufactured in one piece from a plastic, for example polyethylene or polypropylene. Specimen inserts 65 each comprise multiple compartments 70 that serve to receive or retain specimens. Compartments 70 are arranged uniformly on a circle, in other words, in a circular or polar array.

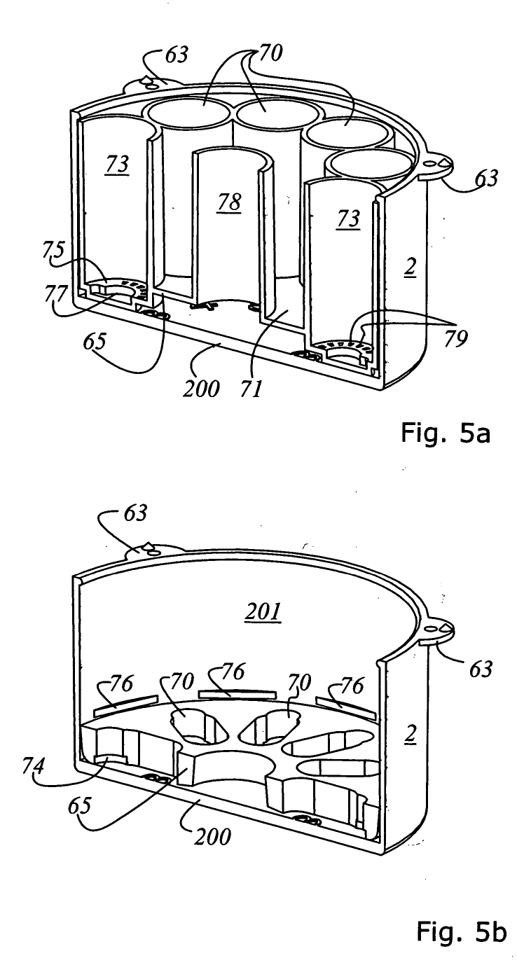

FIG. 5a is a sectioned view of a first embodiment of specimen insert 65 for specimen holder 2, a first embodiment of compartments 70 for receiving a specimen being depicted in the specimen insert. Compartments 70 according to the first embodiment have the shape of a cylinder 73. Compartments 70 are arranged on one shared base 71. Each of the circularly arranged compartments 70 protrudes beyond base 71 in the direction of a base 200 of specimen holder 2. Each compartment 70 is configured, at base 75 of cylinder 73, with a specimen well 77 that is surrounded by multiple openings 79. Openings 79 serve to allow liquid to exit from compartments 70 and collect at base 200 of specimen holder 2. The excess liquid can be removed and conveyed by means of apparatus 10 via a central cylinder 78 of specimen insert 65.

FIG. 5b is a sectioned view of a second embodiment of specimen insert 65 for specimen holder 2, a second embodiment of compartments 70 for receiving a specimen being depicted in specimen insert 65. Configured on one wall 201 of specimen holder 2 are multiple protrusions 76 that hold specimen insert 65 on base 200 of specimen holder 2 so that it is not floated off as liquid is added. Compartments 70 are configured with a groove 74 below which the specimens are clamped or retained during cryosubstitution or low-temperature substitution.

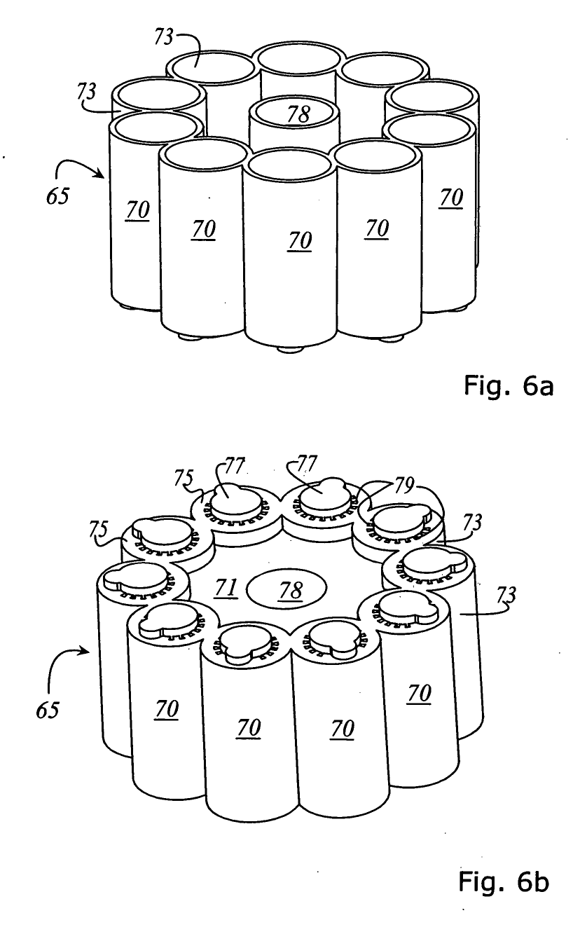

FIG. 6a is a perspective top view of the first embodiment of compartments 70 of specimen insert 65. Compartments 70 have the shape of a cylinder 73 and are arranged in a circle around a central cylinder 78 of specimen insert 65. The specimen insert has substantially the same diameter as specimen holder 2, thereby ensuring a tight fit therein.

FIG. 6b is a perspective bottom view of the first embodiment of compartments 70 of specimen insert 65. Compartments 70 are arranged on one shared base 71. Each compartment 70 is configured, at base 75 of cylinder 73, with a specimen well 77 that is surrounded by multiple openings 79. Specimen well 77 protrudes beyond base 71 of specimen insert 65.

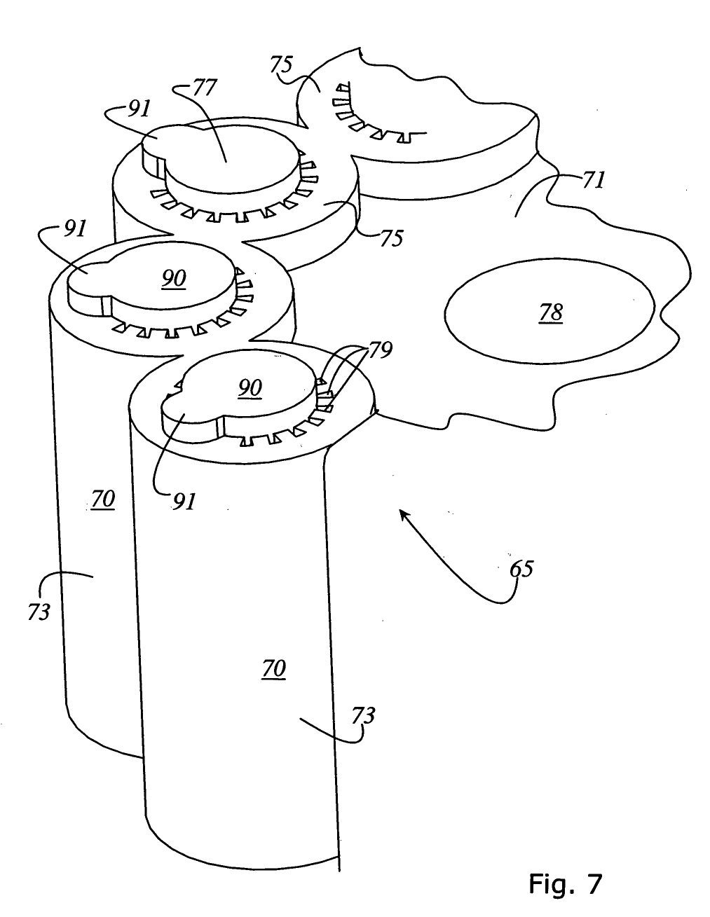

FIG. 7 is an enlarged perspective bottom view of some of compartments 70 of the first embodiment. Specimen well 77 is made up of a circular portion 90 that is embodied centrally on base 75 of cylinder 73. Embodied on circular portion 90 is an approximately semicircular portion 91 that faces radially outward with respect to specimen insert 65. In the region where circular portion 90 is unoccupied by semicircular portion 91, circular portion 90 is surrounded by a plurality of openings 79.

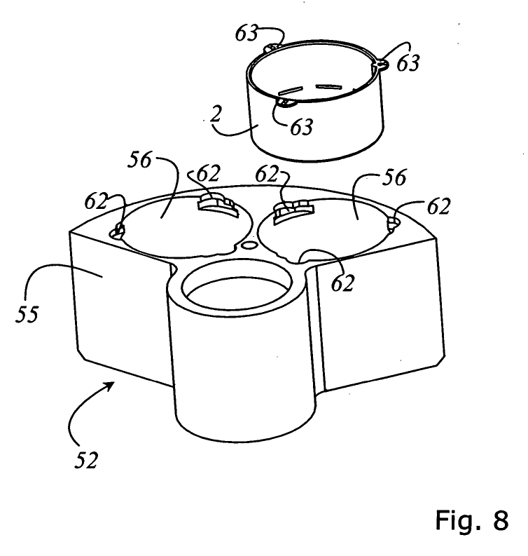

FIG. 8 is a perspective view of first sector 52 for receiving the at least one holding position 56 for specimen holder 2. First sector 52 is embodied as an insert 55 for container 50. Each of holding positions 56 for specimen holder 2 is configured with multiple holding slots 62 that coact with corresponding holding tabs 63 embodied on specimen holder 2. Secure and immovable seating of specimen holder 2 in first sector 52 is achieved by the mechanical interaction of holding slots 62 and holding tabs 63.

What is claimed is:

1. A container for an apparatus for automated cryosubstitution, the container comprising:
a cup having an open top, a first sector, and a second sector, wherein the cup is adapted for insertion into the neck of a Dewar vessel;
a specimen holder arranged in the first sector; and
at least one reservoir holder arranged in the second sector.

2. The container according to claim 1, further comprising an insert arranged in the first sector of the cup, the insert having at least one holding position for the specimen holder.

3. The container according to claim 2, wherein the insert has two holding positions for the specimen holder.

4. The container according to claim 2, wherein the insert and the first sector have substantially the shape of a circle sector.

5. The container according to claim 4, wherein the circle sector has an opening angle of less than 1800 about a center axis.

6. The container according to claim 2, wherein the second sector is an annulus sector in a portion of the cup unoccupied by the insert, and the at least one reservoir holder comprises a plurality of reservoir holders arranged adjacent to one another in the annulus sector.

7. The container according to claim 6, wherein each of the plurality of reservoir holders has a closable opening through which liquid is removable or returnable, and the openings of the plurality of reservoir holders are arranged on a circle and face the open top of the cup.

8. The container according to claim 6, wherein each of the plurality of reservoir holders has the shape of an annulus sector.

9. The container according to claim 2, wherein the at least one holding position for the specimen holder includes a plurality of holding slots that coact with corresponding holding tabs on the specimen holder.

10. The container according to claim 9, wherein three holding elements are distributed regularly on the periphery of the at least one holding position.

11. The container according to claim 1, further comprising a specimen insert for storing specimens during cryosubstitution, wherein the specimen insert is insertable into the specimen holder.

12. The container according to claim 11, wherein the specimen insert is manufactured in one piece from a plastic.

13. The container according to claim 11, wherein the specimen holder is manufactured in one piece from a plastic.

14. The container according to claim 12, wherein the specimen insert comprises a plurality of compartments for receiving specimens, and the plurality of compartments are arranged uniformly on a circle.

15. The container according to claim 14, wherein the plurality compartments are connected by a single shared base; and wherein each of the plurality of compartments protrudes beyond the base, has the shape of a cylinder, and is configured to include a specimen well at a base of the cylinder, wherein the specimen well is surrounded by multiple openings.

16. A system comprising:
a Dewar vessel comprising a neck; and
a container inserted into the neck of the Dewar vessel, the container comprising a cup having an open top, a first sector, and a second sector, wherein the cup is adapted for insertion into the neck of a Dewar vessel, a specimen holder arranged in the first sector; and at least one reservoir holder arranged in the second sector.

17. The system according to claim 16, further comprising an apparatus placed onto the neck of the Dewar vessel for executing automated exchange of liquid between the specimen holder and the at least one reservoir holder.

18. The system according to claim 17, wherein the apparatus comprises a transfer container for holding liquid and an actuation element for intake or ejection of liquid into or out of the transfer container or the sample holder in motorized, pneumatic, or hydraulic fashion.
